(19) United States
(12) Patent Application Publication
(10) Pub. No.: US 2011/0119424 A1
(43) Pub. Date: May 19, 2011

(54) SERVER MANAGEMENT SYSTEM

(75) Inventors: Chih-Wei CHEN, TAIPEI CITY (TW); Hsiao-Fen LU, TAIPEI CITY (TW)

(73) Assignee: INVENTEC CORPORATION, TAIPEI CITY (TW)

(21) Appl. No.: 12/687,887

(22) Filed: Jan. 15, 2010

(30) Foreign Application Priority Data
Nov. 18, 2009 (TW) 98139184

(51) Int. Cl. G06F 13/14; G06F 15/173; F03D 7/04; F04D 29/00

(52) U.S. Cl. 710/305; 709/224; 415/17; 415/118

(57) ABSTRACT

A server management system is provided. The server management system includes a plurality of motherboards, a baseboard, a bus, a first and a second sensor. The baseboard comprises a central control chip to generate a specific instruction. The bus is positioned on the baseboard. The motherboards are connected to the baseboard. Each of the motherboards includes a baseboard management controller (BMC) having an instruction-processing module used to receive the specific instruction through the bus and executes the specific instruction. The first sensor is connected to the central control chip and the second sensor is connected to the BMC. The instruction-processing module retrieves a first state of the first sensor from the central control chip to the BMC and retrieves a second state of the second sensor from the BMC to the central control chip according to the specific instruction.

### RELATED APPLICATIONS

This application claims priority to Taiwan Application Serial Number 98139184, filed Nov. 18, 2009, which is herein incorporated by reference.

### BACKGROUND

1. Field of Invention

The present invention relates to a digital device management system. More particularly, the present invention relates to a server management system.

2. Description of Related Art

A server system generally needs to be connected to various motherboards, and processes the signals on the respective motherboards. In general, a motherboard has an independent system management chip, such as a baseboard management controller (BMC), to manage the motherboard sensors. A concentrated management chip is further disposed on the server. However, different specification of instructions are usually received and processed between the motherboards of different models or manufactured by different companies. As to the concentrated management chip, it is hard to design a common mechanism to control the motherboards manufactured by different companies. The difficulty and the cost to design the mechanism are extremely high thereby obstructing the design of server system.

Hence, it is actually an important and urgent topic for those in this industry to develop a server management system to manage various motherboards manufactured by different companies via a common mechanism.

### SUMMARY

An aspect of the present invention is to provide a server management system that includes a baseboard, a bus, a plurality of motherboards, a first and a second sensor. The baseboard has a central control chip to generate specific instruction. The bus is positioned on the baseboard. The motherboards are connected to the baseboard. Each of the motherboards includes a baseboard management controller (BMC) that has an instruction-processing module used to receive the specific instruction through the bus and executes the specific instruction. The first sensor is connected to the central control chip and the second sensor is connected to the BMC. The instruction-processing module retrieves a first state of the first sensor from the central control chip to the BMC and retrieves a second state of the second sensor from the BMC to the central control chip according to the specific instruction.

In one embodiment, when the central control chip activates the first sensor, the instruction-processing module is notified the baseboard management controller in accordance with the specific instruction that the first sensor has been activated.

In another embodiment, when the central control chip retrieves the first state of the first sensor, the instruction-processing module is updated with a status list according to the specific instruction.

In a further another embodiment, the server management system further includes a fan module, when the second state is a temperature value, the central control chip controls the speed of the fan module according to the temperature value.

In a further another embodiment, the server management system further includes a plurality of status lights, each of which is connected to the central control chip via a communication port, respectively, the central control chip controlling the status lights via the communication port according to the second state. The second state comprises power state, fan state, system state and use state. The status lights comprise the power light, fan-error light, system light, and use light.

In a further another embodiment, the bus supports an intelligent platform management interface (IPMI). The bus is an inter-Integrated circuit (I²C) interface. The specific instruction is in an intelligent platform management bus (IPMB) data specification.

The embodiments of the present invention have the advantage of an instruction-processing module, which is provided by the baseboard management controller of the motherboards, the motherboard of different models or manufactured by different companies are controlled by the central control chip via specific instruction.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram showing a server management system according to an embodiment of the present invention; and

FIG. 2 is a block diagram for furthers illustrating one of the motherboards, baseboard and bus of FIG. 1.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

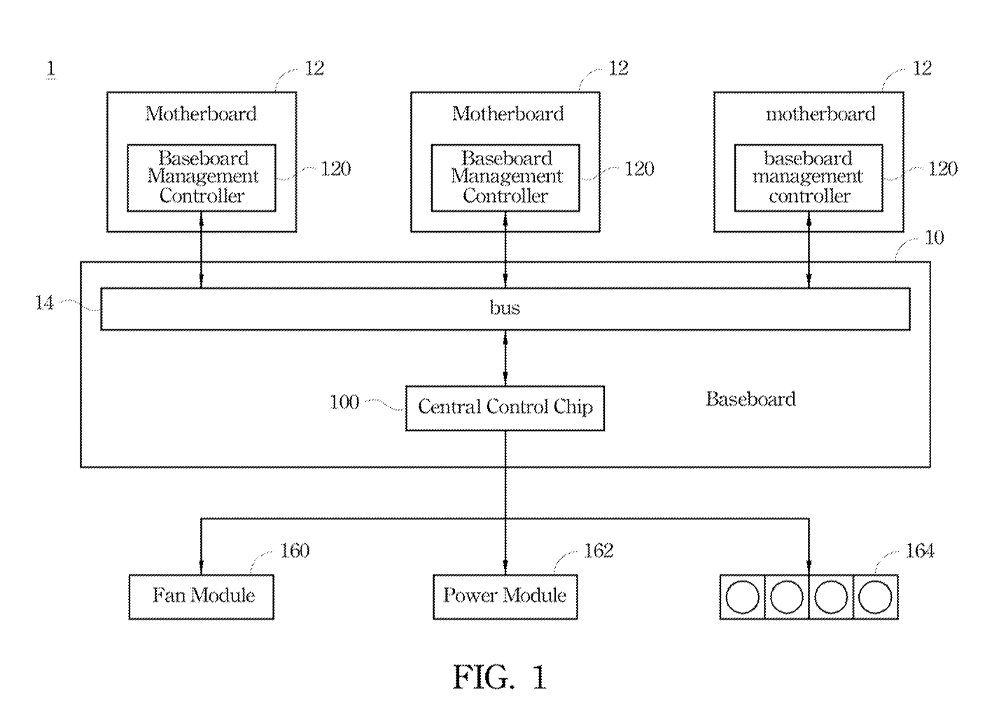

Referring to FIG. 1, FIG. 1 is a block diagram showing a server management system 1 according to an embodiment of the present invention. The sever management system 1 includes the baseboard 10, the motherboards 12 and the bus 14. The baseboard 10 includes the central control chip 100. The motherboards 12 are connected to the baseboard 10. Each of the motherboards 12 includes a baseboard management controller 120. Each of the motherboards 12 communicates with the baseboard 10 via the bus 14. Note that there are three motherboards all numbered 12 in FIG. 1. However, depending on the desired use or function, any amount of motherboards could be adapted instead of being limited to the amount of motherboards in the present embodiment.

The server management system is being connected to multiple motherboards 12 to process signals from the motherboards 12, respectively. However, the instructions in different specifications are usually used to receive and process between different motherboards models and between motherboards manufactured by different companies. As to the concentrated management chip, i.e. the central control chip 100, it is hard to design a common mechanism to control the motherboards 12. The difficulty and the cost to design the mechanism are extremely high thereby obstructing the design of server system.

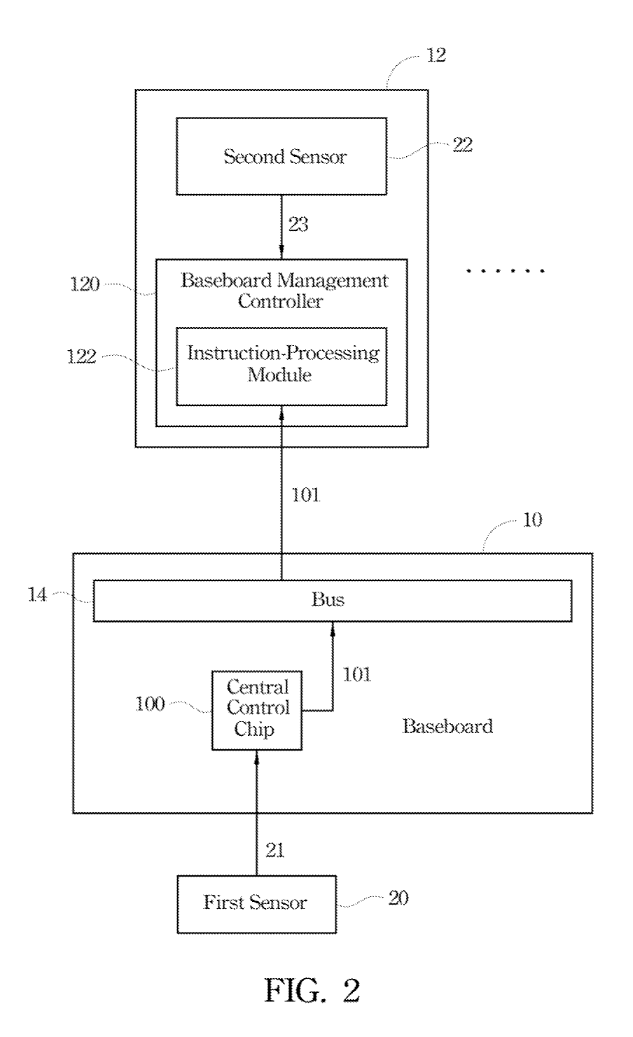

Referring to FIG. 2 and FIG. 1. FIG. 2 is a block diagram to further illustrate one of the motherboards 12, the baseboard 10 and the bus 14 of FIG. 1. The central control chip 100 generates a specific instruction 101 transmitted to the baseboard management controller 120 via the bus 14. In one embodiment, the bus 14 is an I²C interface. The I²C interface supports an intelligent platform management interface (IPMI). Therefore, the specific instruction 101 can be in an intelligent platform management bus data specification.

The baseboard management controller 120 of the motherboard 12 further includes instruction-processing module 122. The instruction-processing module 122 receives the specific instruction 101 generated from the central control chip 100 via the bus 14, and execute the specific instruction 101. As a result, the instruction-processing module 122 is disposed on the motherboard 12 such that the central control chip 100 can control and manage the motherboards 12 of various models or manufactured by different companies via an united specific instruction 101.

As shown in FIG. 2, the server management system 1 further includes the first sensor 20 connected to the central control chip 100. The instruction-processing module 122 retrieves a first state 21 of the first sensor 20 from the central control chip 100 to the baseboard management controller 120 according to the specific instruction 101. When the central control chip 100 activates the first sensor 20, the instruction-processing module 122 is notified the baseboard management controller 120 in accordance with the specific instruction 101 that the first sensor 20 has been activated. When the central control chip 100 retrieves the first state 21 of the first sensor 20, the instruction-processing module 122 is updated with a status list (not shown) according to the specific instruction 101. The baseboard management controller 120 records the states of all sensors of the server management system 1 by means of the status list for controlling the system.

Therefore, the baseboard management controller 120 can control the first sensor 20, which is not directly connected to the baseboard management controller 120, according to the specific instruction 101 of the central control chip 100.

The server management system 1 further includes the second sensor 22. The second sensor 22 is connected to the baseboard management controller 120. In one embodiment, the second sensor 22 is positioned on the motherboard 12 where the baseboard management controller 120 is located. The second sensor 22, similar to the first sensor 20, is to sense the system to generate the second state 23. The second state 23 is transmitted to the baseboard management controller 120 via the second sensor 22 continuously. The instruction-processing module 122 retrieves a second state 23 of the second sensor 22 from the baseboard management controller 120 to the central control chip 100 according to the specific instruction 101.

Therefore, the central control chip 100 can control the second sensor 22, which is not directly connected to the central control chip 100, according to the specific instruction 101.

Referring back to FIG. 1, the server management system 1 further includes the fan module 160, the power module 162, and the status lights 164.

In one embodiment, the fan module 160 communicates with the central control chip 100 via a pulse width modulator (PWN) control interface. As the second sensor 22, as shown in FIG. 2, is employed as a temperature sensor, and the second state 23 generated thereby is a temperature value, such that the central control chip 100 controls the speed of the fan module 160 according to the temperature value. If the temperature value is higher than a predetermined value, the speed of the fan module 160 is increased. If the is temperature value is lower than the predetermined value, the speed of the fan module 160 is reduced, for optimizing the thermal efficiency. The state of the fan module 160 can be supervisory controlled by the baseboard management controller 120 such that the second sensor 22 generates a signal to store in the status list, thereby determining whether the fan module 160 is error. The baseboard management controller 120 can further supervisory control the operation state of system and the condition of service state of all motherboards 12 such that the second sensor 22 generates a signal about the operation state of system and about the service state to store in the status list.

The power module 162 is performed to provide the motherboard 12 and the baseboard 10 the power. Therefore, the second sensor 22, as shown in FIG. 2, is employed as the power sensor of the motherboard 12 such that the second state 23 is regarded as the power state.

In one embodiment, the status lights include the power light, the fan-error light, system light and service light. The lights are controlled according to the power state, the fan state, the system state and the service state generated by the second sensor 22. A user can be notified of the operation state of the server management system 1 according to the status lights. The central control chip 100 retrieves the states via the communication port of general purpose input output (GPIO) to control the status lights. For example, if the fan module 160 is error, the fan-error light will shine to notice the user. If the information is processed within one of the motherboards 12, the corresponding service light will shine to notice the user that which motherboard is operated.

The embodiments of the present invention have the advantage of instruction-processing module, which is provided by the baseboard management controller of the motherboards. The motherboards of different models or manufactured by different companies are controlled by the central control chip via specific instruction.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A server management system, comprising:
a baseboard comprising a central control chip to generate a specific instruction;
a bus positioned on the baseboard;
a plurality of motherboards connected to the baseboard, each of the motherboards including a baseboard management controller, wherein the baseboard management controller has an instruction-processing module used to receive the specific instruction through the bus and execute the specific instruction;
at least one first sensor connected to the central control chip; and
at least one second sensor connected to the baseboard management controller,
wherein the instruction-processing module retrieves a first state of the first sensor from the central control chip to the baseboard management controller and retrieves a second state of the second sensor from the baseboard management controller to the central control chip according to the specific instruction.

2. The system of claim 1, wherein, when the central control chip activates the first sensor, the instruction-processing module is notified in accordance with the specific instruction that the first sensor has been activated.

3. The system of claim 2, wherein when the central control chip retrieves the first state of the first sensor, the instruction-processing module is updated with a status list according to the specific instruction.

4. The system of claim 1, further comprising:
a fan module, wherein when the second state is a temperature value, the central control chip controls the speed of the fan module according to the temperature value.

5. The system of claim 1, further comprising:
a plurality of status lights, each of the status lights is connected to the central control chip via a communication port, respectively, the central control chip controlling the status lights via the communication port according to the second state.

6. The system of claim 5, wherein the second state is a power state, a fan state, a system state or a service state, and the status light is a power light, a fan-error light, a system light or a service light.

7. The system of claim 1, wherein the bus supports an intelligent platform management interface (IPMI).

8. The system of claim 1, wherein the bus is an inter-Integrated circuit (I²C) interface.

9. The system of claim 1, wherein the specific instruction is in an intelligent platform management bus data specification.
